(19) United States
(12) Patent Application Publication
(10) Pub. No.: US 2010/0228538 A1
(43) Pub. Date: Sep. 9, 2010

(54) COMPUTATIONAL LINGUISTIC SYSTEMS AND METHODS

(76) Inventor: John A. YAMADA, San Lorenzo, CA (US)

Correspondence Address: NIXON PEABODY, LLP, 401 9TH STREET, NW, SUITE 900, WASHINGTON, DC, 20004-2128, US

(21) Appl. No.: 12/397,288

(22) Filed: Mar. 3, 2009

(51) Int. Cl. G06F 17/27; G06F 17/28; G06F 17/00

(52) U.S. Cl. 704/9; 704/4; 706/47

(57) ABSTRACT

An apparatus and corresponding method are disclosed for selecting and managing morphological, syntactic and semantic information found in natural languages using a reduced instruction set grammar (RISG). The apparatus and corresponding method 1) convert natural language inputs into morphological tokens and stores those tokens, 2) convert morphological tokens into syntactic groups and stores those groups, and/or 3) convert syntactic groups into semantic blocks and stores those blocks, and vice versa. The process can start with text and find the corresponding morphological tokens, syntactic groups and/or semantic blocks or start with semantic block(s) and find the corresponding morphological tokens.

### BACKGROUND

1. Field

The subject invention relates to systems and methods for computationally analyzing natural languages.

2. Related Art

Currently, computational approaches to natural language processing (NLP) are built around context free grammars; natural languages, however, are context sensitive grammars. Context free grammars are at the heart of many computational devices—computer programming languages are context free grammars, HTML display language is a context free grammars to describe and manage display information, etc. Using context free grammars to model natural languages, however, typically leads to numerous problems, such as over-generation. Over-generation occurs when a grammar produces illegal combinations of terminals or ill-formed structures. For example, using context free grammars may create the following sentences: I run, you run, she run. In this example, she run is an over-generation because it is ungrammatical. On the other hand, using context sensitive grammars on computational devices is difficult. For example, Humphreys et al. explains: “ . . . As noted previously, producing a generation grammar is a difficult task, and conversion of analysis grammars into a generation grammar is a complex task due to the large number of conditions which govern the application of specific rules.” See, Humphreys et al., U.S. Pat. No. 7,266,491 (beginning at col. 6, line 42).

Alan Turing is the father of modern computational theory. There are four basic automatons or machines that define what can be computed: Turing Machine, Linear Bounded Automata, Push Down Stack (also referred to as Push Down Automata) and Finite State Automata. A Turing Machine is a computational device with an infinite tape to read and write data, a Linear Bounded Automata (LBA) is a computational device with a finite tape to read and write data, a Push Down Stack is a computational device where data is read and written in a first-in, first-out fashion, and a Finite State Automata is a computational device that can process predefined states. Modem computers are usually considered to be Turing Machines with unlimited paper tapes, even though they are actually LBAs with extremely large finite tapes.

Noam Chomsky is the father of modern linguistic theory, and contributed to computational theory with a hierarchy of computational grammars. The basic computational grammars are: Unrestricted Grammars, Context Sensitive Grammars, Context Free Grammars and Regular Grammars. The relationship between Turing's automatons and Chomsky's grammars is: Unrestricted Grammars (Turing Machines), Context Sensitive Grammars (Linear Bounded Automata), Context Free Grammars (Push Down Stack) and Regular Grammars (Finite State Automata).

Modern computational theory is a cohesive and comprehensive body of work, while modern linguistic theory is anything but cohesive. Over the years, Noam Chomsky and his disciples have proposed a number of theories to explain natural language processing—each theory is attractive in its own way, but also has significant drawbacks. These theories include Phrase Structure Grammars, X-bar Projection, Theta Roles, Minimalist Theory, Working Memory Hypothesis, etc.

Phrase Structure Grammars were proposed by Chomsky in Syntactic Structures (1957). Phase structure grammars are a series of rewrite rules and associated transformations. The production rules replace tokens on the left-hand side of the production rule with those on the right-hand side.

X-bar Projection was proposed by Chomsky in “Remarks on Normalization” in 1970 and addressed why rewrite rules fell into categories dominated by certain linguistic objects (e.g., nouns and verbs). X-bar Projection is a flexible way for performing transformation grammars using a common starting backbone. The fundamental problem with the approach was that it was not flexible enough, and new “forces” had to be invented to move things around. In a much simplified form, it is used today as part of Chomsky's Minimalist program.

Theta Roles were proposed by David Pesetsky in 1982 based on earlier work by Chomsky and deals with the interaction between verbs and objects. Theta Roles were originally conceived as a comprehensive theory of semantics with respect to syntax. The problem with the theory was that linguists could not agree on a comprehensive set of semantic roles for each verb. Theta Roles have been generally abandoned, and much of its functionality in semantic theory has been replaced by other theories.

Chomsky proposed Minimalist Theory in the 1990s in an attempt to develop a computational theory to describe natural language phenomena that stripped away computational complexity and developed a simple core processing model.

Thus, what is needed is a computational natural language processing system and method to handle context sensitive grammars.

### SUMMARY OF TEE INVENTION

The following summary of the invention is included in order to provide a basic understanding of some aspects and features of the invention. This summary is not an extensive overview of the invention and as such it is not intended to particularly identify key or critical elements of the invention or to delineate the scope of the invention.

An apparatus and corresponding method are disclosed for selecting and managing morphological, syntactic and semantic information found in natural languages using a reduced instruction set grammar (RISG). Reduced Instruction Set Grammar (RISG) is a simplified context sensitive grammar specification used to construct context sensitive grammars (CSGs) for natural language processing. RISG takes a number of linguistic phenomena and maps them into modern computational theory. The core of the invention is the combination of two context sensitive grammars, x-bar and theta rules, to simplify natural language processing. The RISG process operates on an input stream of characters to create a model of natural language processing (NLP).

The RISG apparatus and corresponding method 1) convert natural language inputs into morphological tokens and stores those tokens, 2) convert the morphological tokens into syntactic groups and stores those groups, and/or 3) convert the syntactic groups into semantic blocks and stores those blocks. The process can start with text and find the corresponding morphological tokens, syntactic groups and/or semantic blocks (i.e., syntactic reduction) or start with semantic block(s) and find the corresponding morphological tokens (i.e., syntactic expansion). The RISG apparatus and corresponding method also allow: 1) loading a lexicon using a simplified description of a natural language, 2) changing the morphological state of the apparatus, 3) performing syntactic generation or expansion by entering semantic input tokens and receiving back terminals, and/or 4) performing syntactic reduction by entering terminals and receiving semantic tokens.

The apparatus and corresponding method are built around the core concepts of Chomskyean linguistics such as phrase structure grammars, X-bar projection, Theta roles, and Minimalism, and provide a context sensitive approach to computational grammars. These linguistic concepts are implemented as simplified methods using concepts from modern computational theory such as finite state automatons, push down stacks and linear bounded automatons.

According to an aspect of the invention, a natural language processing system is provided that includes a data store having a morphological look-up table; a data store having a plurality of x-bar rules; a data store having a plurality of theta rules; and a processor to receive an input, process the input using one or more of the x-bar rules, one or more of the theta rules, and the morphological look-up table to produce an output.

The system may also include a data store having environment data. The data store may store environment settings that are nested using a push down stack. The processor may process the input using the environment data.

The input may include semantic tokens. The processor may be configured to perform a syntactic expansion of the semantic tokens using the one or more theta rules, one or more x-bar rules, and the morphological look-up table to produce terminals.

The input may be terminals. The processor may be configured to perform a syntactic reduction of the terminals using the morphological look-up table, one or more x-bar rules, and one or more theta rules to produce semantic tokens.

The morphological look-up table may include morphological table data and terminal tagging data.

The processor may be configured to: select at least one of the x-bar rules and at least one of the theta rules when the processor is processing the input if at least one of the x-bar rules and at least one of the theta rules are mappable to the input; select at least one of the x-bar rules if at least one of the x-bar rules is mappable to the input and no theta rules are mappable to the input; select at least one of the theta rules if the at least one of the theta rules is mappable to the input and no x-bar rules are mappable to the input; and process the input if no theta rules and no x-bar rules are mappable to the input.

The system may include a lexicon, the lexicon including the data store having the morphological look-up table, the data store having the plurality of x-bar rules, and the data store having the plurality of theta rules.

Each theta rule may include a key list, an operator and one or more tokens, and wherein each token comprises a variable or a terminal. The input may include one or more tokens, each token comprising a variable or a terminal, and wherein the processor may be configured to: map each variable in the input to the key list to identify a theta rule; and replace each token in the input with the one or more tokens of the identified theta rule.

The x-bar rules may be conditional phrase structure rules.

The morphological table may include a plurality of table records, each table record including a preamble that is an environment list and a terminal list corresponding to the preamble. The processor may be configured to decode the table record based on one or more current environment settings and the preamble, and to identify a terminal in the terminal list by calculating a table offset based on the one or more current environmental settings for the morphological table.

The system may also include a data store having a plurality of unit production rules. The processor may be configured to identify one or more unit production rules and generates one or more spanning trees or groups of spanning trees for the input and map each of the one or more spanning trees or groups of spanning trees to at least one of the plurality of theta rules. Each unit production may include one or more attributes corresponding to a token. The processor may be configured to identify a unit production rule for the input by matching a token in the input with the token in the unit production.

According to another embodiment of the invention, a natural language processing method is provided that includes receiving a semantic input; mapping the semantic input to at least one theta rule to generate at least one theta-rule clause; mapping each theta-rule clause to one or more x-bar rules; modifying each theta-rule clause with the one or more x-bar rules; and replacing tokens of the modified theta-rule clause with terminals using a morphological look-up table to generate a terminal output.

The input may include one or more tokens, each token comprising a variable or a terminal, and the process may also include mapping each variable in the input to the key list to identify a theta rule; and replacing each token in the input with the one or more tokens of the identified theta rule.

Mapping the semantic input to a theta rule may include generating one or more spanning trees from the semantic input and mapping the one or more spanning trees to the at least one theta rule.

The method may also include determining environment data for the semantic input.

The setting for the environment data may be initialized with a default value. The method may also include changing the setting for the environment data if a peg in the semantic input corresponds to a table record in an environment data store based on the table record. The settings for the environment data may be nested using a push down stack.

The method may also include attaching environment data to the input using one or more unit productions. The one or more unit productions may each assign one or more attributes to one or more tokens in the semantic input.

The method may also include identifying an x-bar rule based on the one or more tokens in the semantic input. If the x-bar rule includes pegs, the method may also include evaluating a current setting of environment data and, if the pegs in the x-bar rule correspond to the current setting, replacing each variable in the x-bar rule with non-peg tokens in the x-bar rule.

The method may also include performing one or more swap and join operations on the terminals before outputting the terminal output.

According to another embodiment of the invention, a natural language processing method is provided that includes receiving a terminal input; generating a terminal tag containing one or more tokens for each terminal in the terminal input; mapping the generated terminal tags to at least one x-bar rule; replacing the generated terminal tags with combined terminal tags using the at least one x-bar rule; mapping the combined terminal tags to at least one theta rule to generate semantic output; and outputting the semantic output.

Generating the terminal tag may include matching the terminal input with one or more variables and one or more pegs.

Mapping the generated terminal tags to at least one x-bar rule may include combining two or more adjacent terminal tags into the combined terminal tag.

Mapping the one or more variables to the at least one theta rule may include generating one or more spanning trees or groups of spanning trees for the one or more variables and mapping the one or more spanning trees or groups of spanning trees to at least one theta rule.

The method may also include performing one or more swap and join operations on the terminal input. The method may also include performing one or more swap and join operations on the semantic output.

According to another embodiment of the invention, a natural language processing method is provided that includes receiving a semantic input; performing a theta rule expansion on the semantic input; performing an x-bar expansion on one or more variables of the theta rule expanded semantic input; performing a morphological table lookup on the x-bar and theta rule expanded semantic input to generate a combined terminal tag.

According to another embodiment of the invention, a natural language processing method is provided that includes receiving a terminal input; tagging the terminal input to match the terminal input with one or more variables and one or more pegs using a reverse lookup table; performing one or more x-bar reductions on the tagged terminal input; and performing a theta reduction on the x-bar reduced tagged terminal input to generate a semantic output.

According to another embodiment of the invention, a natural language processing system is provided that includes a data store having a morphological look-up table; a data store having a plurality of x-bar rules; a data store having a plurality of theta rules; a data store having environment data; a data store having a plurality of unit production rules; and a processor to receive an input, process the input using the one or more of the x-bar rules, one or more of the theta rules, one or more of the plurality of unit production rules, the environment data and the morphological look-up table to produce an output. The input may include terminals or semantic tokens.

Exemplary advantages of the computational natural language processing systems and methods described herein include: more accurate natural language processing (both for expansion and reduction), much faster processing than current methods, the ability to process on personal computers and handheld devices, and the like. The systems and methods described herein can be used, for example, to improve grammar checkers for word processing programs (e.g., Microsoft Word), improve database and web searching query tools (e.g., Google), build very accurate natural language translation systems by mapping between different languages at the semantic level and not the terminal level, improve tools for converting programs written in one natural language into a different language (localization), perform natural language syntax processing, improve the performance of statistical machine translation systems on personal computers and small handheld devices, and the like.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of a computational linguistic system in accordance with one embodiment of the invention;

FIG. 2 is a schematic flow and system diagram for a computational linguistic system in accordance with one embodiment of the invention;

FIG. 3 is a schematic flow and system diagram of a lexicon of the computational linguistic system in accordance with one embodiment of the invention;

FIG. 4 is a flow diagram of semantic tokens to output terminals computational linguistic method in accordance with one embodiment of the invention;

FIG. 5 is a flow diagram of a syntactic generation/expansion process in accordance with a computational linguistic method in accordance with one embodiment of the invention;

FIG. 6 is a flow diagram of a terminal input to semantic token output computational linguistic method in accordance with one embodiment of the invention;

FIG. 7 is a flow diagram of a syntactic reduction process in accordance with a computational linguistic method in accordance with one embodiment of the invention;

FIG. 8 is a schematic process and system diagram of a computational linguistic system in accordance with one embodiment of the invention;

FIG. 9 is a schematic process and system diagram of a computational linguistic system in accordance with one embodiment of the invention;

FIG. 10 is a flow diagram for determining the environment settings in a computational linguistic process in accordance with one embodiment of the invention;

FIG. 11 is a flow diagram for identifying a theta rule in a computational linguistic process in accordance with one embodiment of the invention;

FIG. 12 is a flow diagram for identifying an x-bar rule in a computational linguistic process in accordance with one embodiment of the invention; and

FIG. 13 is a schematic diagram of a computer system in accordance with one embodiment of the invention.

### DETAILED DESCRIPTION

An explanation of some of the terms and lexical notations used herein is provided below to aid in understanding of the description that follows. It will be appreciated that the notations, assignment operators, and the like, are merely exemplary and may vary from that described herein.

In the following description, a new relationship between internal process constituents may be defined using a colon:

new-constituent-name:
a b c d . . .
   It will be appreciated that there is no limit on the number of constituents in a relationship, and that the colon is used for internal processing purposes (i.e., it is not part of the definition of the external input language). Multiple possible definitions may be defined with multiple lines:

new-constituent-name:
a b c d . . .
aa bb cc dd . . .
aaa bbb ccc ddd . . .
   It will be appreciated that new constituents can also be defined within the general description of the process. Exemplary new constituents include:

key-list: key-variable terminal-list

right-side-expansion:
right-side-list
peg-list right-side-list
(peg-list) right-side-list
   It will also be appreciated that in this description, an embedded dash and space are equivalent. For example, “key-list” and “key list” or “variable-list” and “variable list” describe the same concepts.

In the description that follows, data objects, which are collections of data elements, are delimited with opening and closing curly brackets which are “{” and “}”

data-object-name: {
}

Data objects are not part of the external input language. Exemplary data objects include:

```
lexicon-data-object: {
  language-name
  environment-data-object
  morphological-table-data-object
  x-bar-projection-data-object
  theta-expansion-data-object
}
```

A token is any arbitrary number or sequence of characters. Tokens include terminals and variables. Terminals are the surface expression of a natural language. Variables express the internal workings of a natural language. Pegs are a type of variable, and are linguistic constants.

A line is any arbitrary number of characters terminated with a carriage return or a carriage return and line feed (depending on the operating system). A white-space-character is a space, tab, comma etc. White-space is defined as any arbitrary number or sequence of white-space-characters. A reserved-character is: ‘”’ (double-quote), ‘<’ (left angle), or ‘>’ (right angle). A special-character is: ‘_’ (under-score), or ‘˜’ (tilde). A delimiter is defined as the start of a line, the end of a line, white-space, dyadic-token, monadic-token or reserved-character. A dyadic-token (two character) is: :=, →, =>, =, /*, */, or //. A monadic-token (single character) is: ‘+’ plus-sign, ‘(’ left-parenthesis, ‘)’ right-parenthesis. Dyadic-tokens and monadic-tokens are system-tokens. Dyadic-tokens have lexical precedence over monadic-tokens. A regular-token is any arbitrary number or sequence of characters defined by delimiters. A regular-token may include reserved-characters but not other delimiters. Dyadic-tokens and monadic-tokens have lexical precedence over regular-tokens. A variable is any regular-token starting with a single ‘<’ (left-angle) and ending with a single ‘>’ (right-angle). Any white-space in a variable is discarded. A variable can include special-characters. In the description that follows, variables that are expressed as upper or lower case text are equivalent (e.g., <Aller>, <aller> and <ALLER> are equivalent). A literal is any regular-token starting with a “ ” (double-quote) and ending with a “ ” (double-quote). During processing, the “ ” (double-quotes) are removed from literals. The resulting regular-token may contain embedded white-space. A terminal is any regular-token that is not a variable.

A comment-block starts with the ‘/*’ token and terminates with the ‘*/’ token. A comment-block does not nest. Any tokens within a comment-block are ignored. A comment can also start with the ‘//’ token and terminates at the end of the line. Any tokens in a line occurring after a ‘//’ token are ignored.

The following tokens are reserved-words:

```
reserved-word:
  <~SWAP>
  <NULL>
  “” (two double-quotes)
  _(under-score)
```

An empty-string is a string that contains no characters. An empty string is defined as:

```
empty-string:
  <NULL>
  “” (two double-quotes)
  _(under-score)
```

All three forms of the empty-string are equivalent. Empty-strings are regular-tokens.

A system-operator can be a dyadic-operator, a monadic operator or a reserved-word and may be expressed as:

system-operator:
dyadic-operator
monadic-operator
reserved-word

A token-list is defined as any arbitrary sequence of tokens. A variable-list is a token-list consisting of any arbitrary sequence of variables and only variables. A terminal-list is a token-list that includes any arbitrary sequence of terminals (but only terminals). A key-variable is a variable used by the RISG process to store, index and retrieve information in a data storage object. A key-list is a token-list that starts with a key-variable. A key-list contains one or more tokens. A key-list is:

key-list: key-variable terminal-list

A peg-list is a variable-list that only includes pegs.

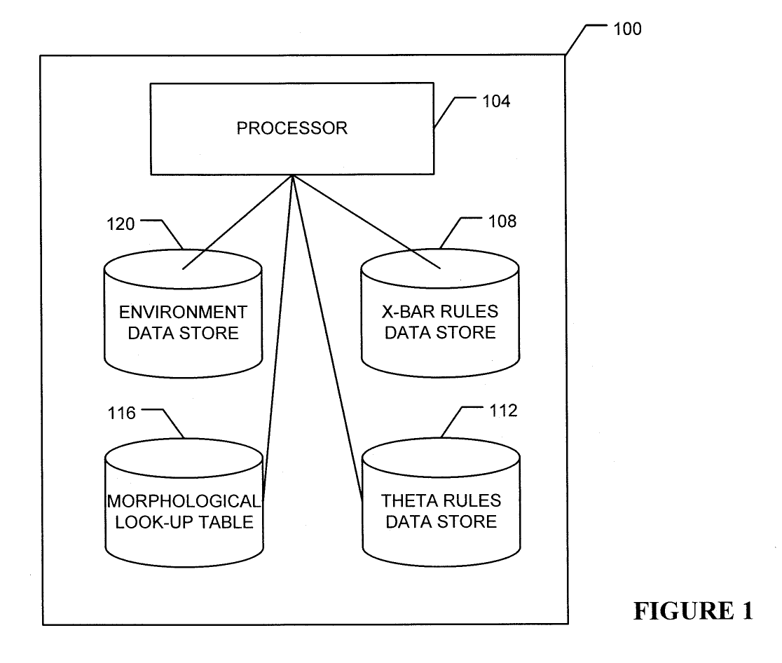

An embodiment of the invention will now be described in detail with reference to FIG. 1. As shown in FIG. 1, a computational linguistic system 100 includes a processor 104, an x-bar rules data store 108, a theta rules data store 112, a morphological look-up table 116 and an environment data store 120. It will be appreciated that the arrangement of the components may differ from that shown in FIG. 1 below and that the system may include additional or fewer components than shown in FIG. 1. It will also be appreciated that the data stores may include databases to store the data. In addition, the data stores may be connected to the processor over a network (i.e., in a distributed computing system). Alternatively, some or all of the data stores may be provided on a single memory device that is connected to the processor (e.g., as data objects stored in memory).

The x-bar rules data store 108 is configured to store x-bar rules. X-bar rules are configured to provide conditional phase structure information for the natural language being processed. In other words, the x-bar rules are conditional phase structure rules. Conditional phrase structure rules are phrase structure rules that are valid and not based on the current morphological state of the system. An exemplary format of an x-bar rule is:

projection-rule: key-variable=>right-side-expansion

The right side expansion of a projection rule may be an empty string (i.e., the right side is empty or only includes pegs). The x-bar rules can have the exemplary forms:

```
conditional-phrase-structure-rule:
  variable => variable-list
  variable => ( peg-list ) variable-list
  variable => terminal
```

Rules that include a peg-list are first validated by comparing the peg-list with the current morphological state or environment state of the apparatus. An exemplary x-bar rule in English is:

<Verb>=><Pronoun><Verb>

The x-bar rules may be organized in the data store 108 by projection classes. A projection class is a collection of one or more projection rules that share the same variable (e.g., same projection variable). An exemplary format of the projection class is:

projection-class-assignment: variable=>projection-class

For example, in English, the variable <Run> can be assigned to the projection class <Verb> in the following way:

<Run>=><Verb>

It will be appreciated that in the present description that references to “xbar” and “x-bar” are equivalent.

The theta rules data store 112 is configured to store theta rules. Theta rules are configured to provide syntactic and semantic information for the natural language being processed. An exemplary format of a theta-rule is:

theta-rule: key-list→right-side-expansion

An exemplary right side expansion has the form:

```
right-side-expansion:
  right-side-list
  peg-list right-side-list
  ( peg-list ) right-side-list
```

The right-side-list may be a combination of monadic-operators, reserved-words and token-lists, or it may be empty. Theta rules may also be organized in the data store 112 according to theta rule classes—the theta rule class may be defined by the key-variable (i.e., from the left side key list). Below are three exemplary theta rules for the French verb “aller” (to go, in English):

<Aller> -> <Aller> à<City>
<Aller> -> <Aller> en <FSRegion>.
<Aller> <FSRegion> -> <Aller> en <FSRegion>

The key list of the theta rule may also include terminals. For example, the following theta rules include variables and terminals:

<Etre> certain -> <Neg> <3><S> <Etre> certain que ( <Subj> )
<Etre> evident -> <Neg> <3><S> <Etre> evident que ( <Subj> )

The environment data store 120 is configured to store current environment settings. The environment is a collection of the linguistic constants (e.g., masculine vs. feminine, first person vs. second person vs. third person, singular vs. plural) or the attributes that a natural language is built around. An exemplary format of the environment data is:

environment-rule: environment-group:=variable-list

The environment group is a key variable. A peg is any variable in the right side variable list of an environment group definition. The environment list is a variable list that includes any variable in that environment (i.e. environment-groups or pegs). It will be appreciated that the key variable in the environment group is different from the variables that appear in the right side variable list. In one embodiment, all variables specified in the environment have precedence of other operational uses in the grammar. For example, in English, the definition for the person, number and gender attributes are:

| | | |
|---|---|---|
| <Gender> := <Male> <Female> | or | <Gender> := <M> <F> |
| <Person> := <First> <Second> <Third> | or | <Person> := <1> <2> <3> |
| <Number> := <Singular> <Plural> | or | <Number> := <S> <P> |

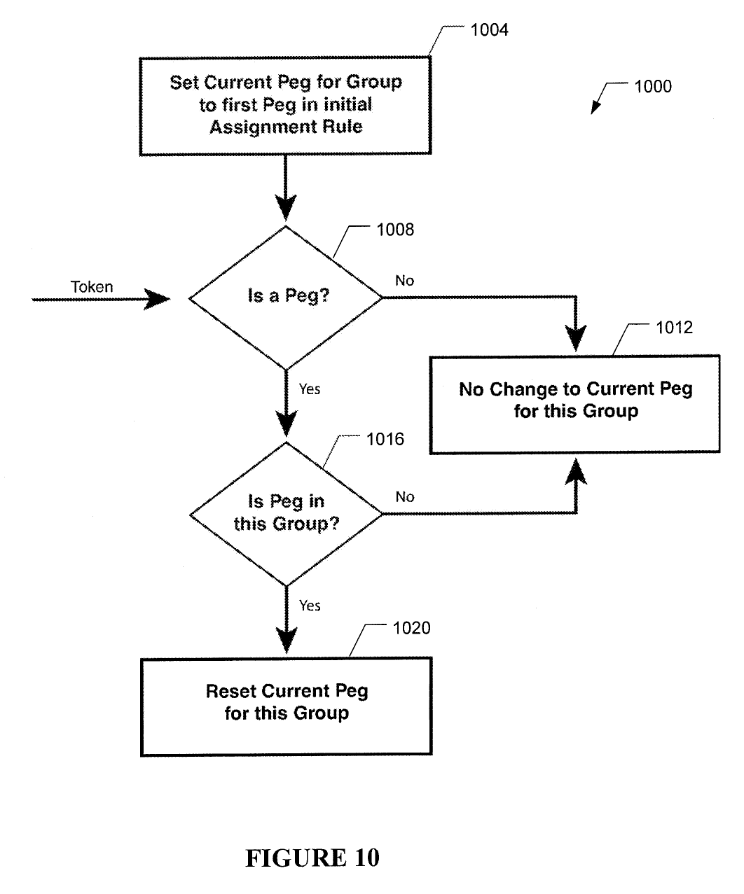

The default values of the environment are the first peg on the right hand side of each environment group (e.g., <M>, <1> and <S> in the example above). The current peg setting for each environment-group is stored in the environment data store 120. The initial setting stored in the environment data store 120 is the default value. The processor 104 is configured to change the current setting of the associated environment group stored in the environment data store 120 when a valid peg is received at the processor 104, as described in further detail below with reference to FIG. 10. A push down stack is provided to manage sets of current-peg-settings.

The morphological look-up table 116 is configured to store morphological tokens. In one embodiment, the morphological look-up table 116 also includes a reverse look-up table. In another embodiment, a separate reverse look-up table may be provided. The morphological data is stored as morphological table records in the look-up table(s). An exemplary format of the table records is:

table-data: key-variable=(preamble) terminal-list.

The preamble is an environment list that is used to identify the terminal to be used for the particular variable. For example, the morphological look-up table entries for personal pronouns (i.e., the variable <PP>) in English are:

<PP> == (<M> <Number> <Person>) I, you, he, we, you, they
<PP> == (<F> <Number> <Person>) I, you, she, we, you, they

The preamble is used to decode the table records using the current environment settings. In one embodiment, the table records are decoded by calculating a table-offset that identifies the location of the terminal in the table record (e.g., “1” corresponds to “I” and “6” corresponds to “they” in the above example). In one embodiment, the table-offset is determined by the formula:

prior-group-size*(prior-peg-position 1)+current-peg-position

If the value for the table-offset is greater than the size of the terminal-list, <Null> may be returned.

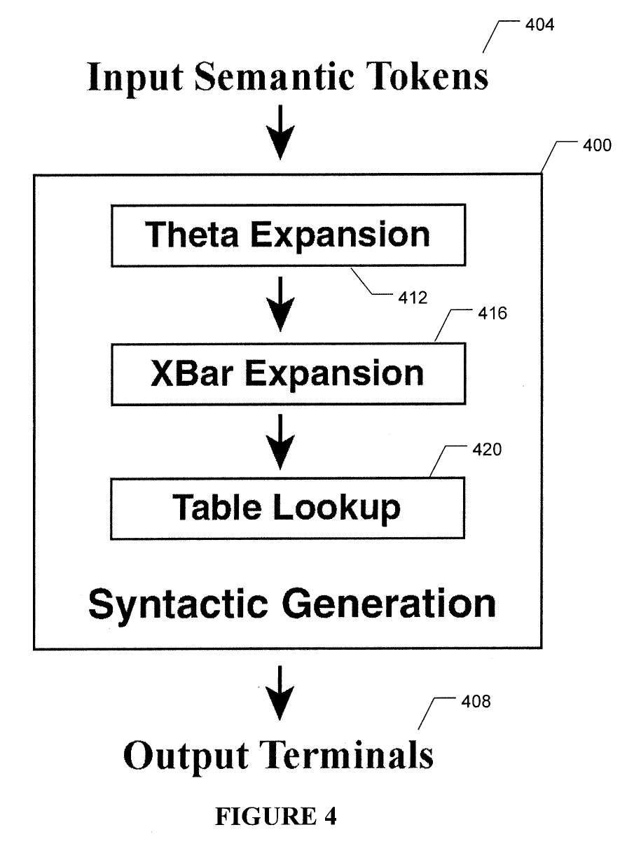

The processor 104 is configured to receive an input, process the input using one or more of the x-bar rules, one or more of the theta rules, the morphological look-up table and the environment data to produce an output. The input is an arbitrary sequence of tokens, which may be semantic tokens (e.g., for syntactic expansion) or terminals (e.g., for syntactic reduction). The processing of the input is described in further detail with reference to FIGS. 4-8.

In one embodiment, the system 100 also includes a unit production data store (not shown) that is configured to store unit productions. Unit productions are used to attach environment and other semantic information to specific terminals or variables in the language. The unit productions assign the attributes by assigning tokens (e.g., pegs or variables) to the terminals or variables. An exemplary format of a unit production is:

unit-production: variable→token

For example, in the French language, the following locations are assigned the attribute of a <City>:

<City> -> Paris
<City> -> Venise

Some of the cities are also assigned the attribute that they are capitals:

<Capital>→Paris

With these two sets of unit-productions, Paris is now considered both a <City>and <Capital>, while Venise is only a <City>. In another example, the variable <FSRegion> is defined by the attributes feminine, singular and region using the following rules:

<F> -> <FSRegion>
<S> -> <FSRegion>
<Region> -> <FSRegion>

The processor 104 may optionally be configured to generate spanning trees using the unit production rules. A spanning tree is a set of connected unit productions, and may include pegs, variables and terminals. A spanning-tree has a root or initial token, which can be either a terminal or variable, but not a peg. The spanning tree pegs are collected in a peg-list, and are pegs associated with the root token. The pegs of a spanning tree should be consistent with those of the root token. A set of pegs is consistent if there is only one peg in the set from an environment group. The spanning-tree-tokens include all the other variables and terminals. An exemplary format of the spanning tree token is:

spanning-tree-token:
token
(peg-list) token
   An exemplary process for generating the spanning tree is provided below:

spanning-tree:
root-token
root-token=spanning-tree-token and/or
spanning-tree-token=spanning-tree-token
   The root-token by itself is a valid spanning-tree. Each non-peg token in the spanning tree should be unique. Spanning trees have an inherently recursive definition. In the examples that follows, a spanning tree equivalency is represented with ‘=’ (a single equal sign); <A>=<B>=<C> is an exemplary spanning tree. An exemplary spanning tree for “Paris” using the above unit production rules is:

Paris=<City>=<Capital>

That is, “Paris is a <City> and a <Capital>”. In another example, the spanning tree pegs for “<Region>” are <F> and <S>, and the spanning tree tokens are <FSRegion> and <Region>. The conditional-spanning-tree is:

<Region>=(<F><S>)<FSRegion>

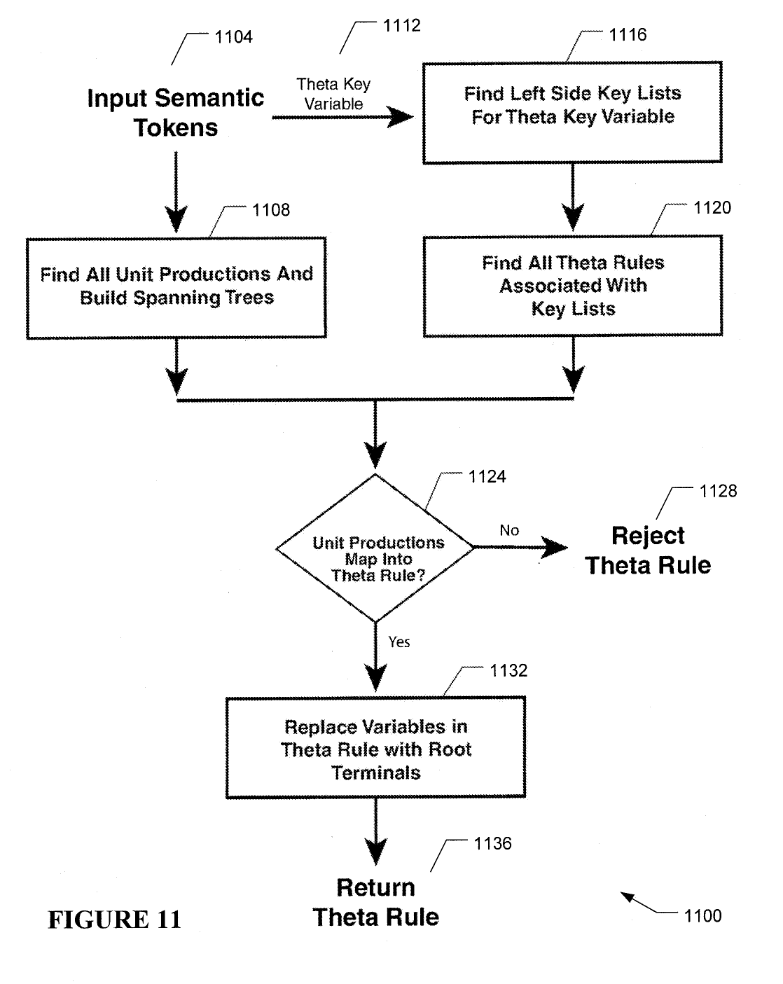

This is equivalent to saying “a <Region> that is <F> and <S> is a <FSRegion>”. In one embodiment, the processor 104 is configured to identify theta rules in the theta rule data store using the spanning trees and/or unit productions as will be described in further detail with reference to FIG. 11.

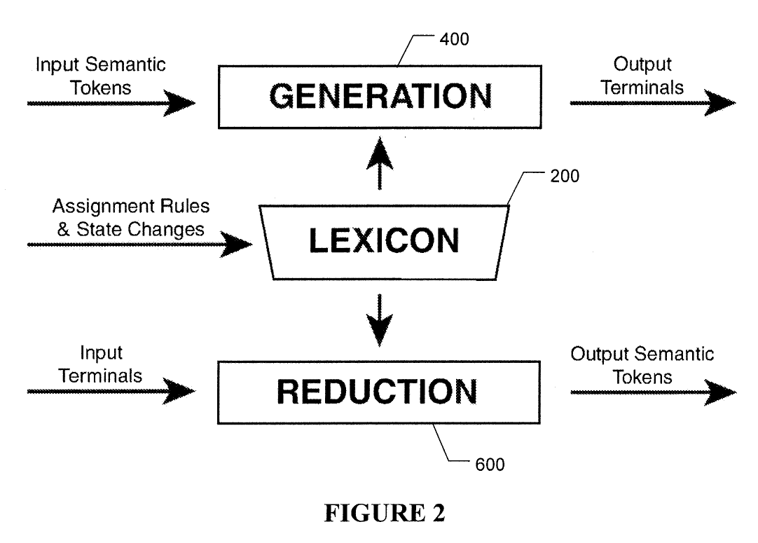

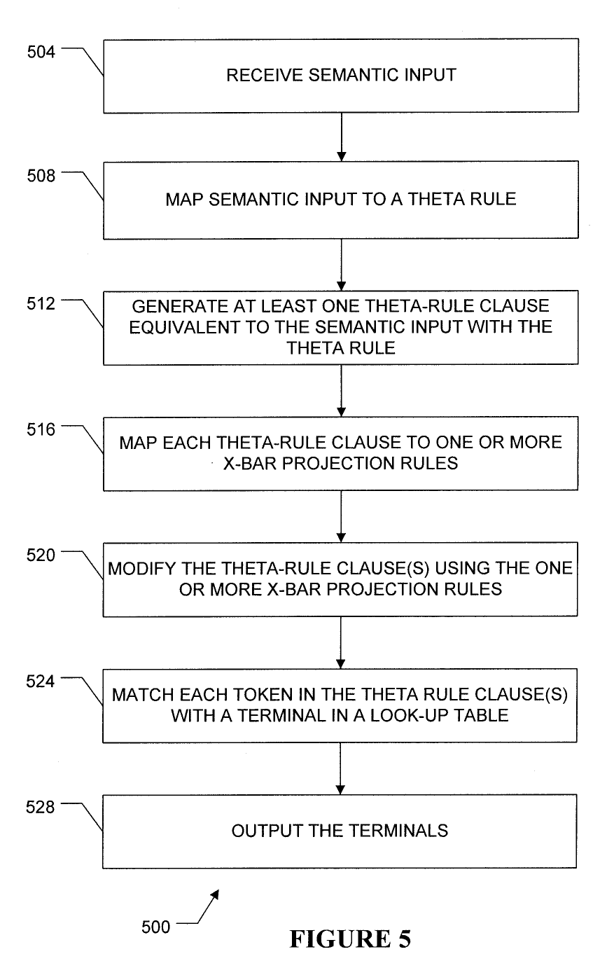

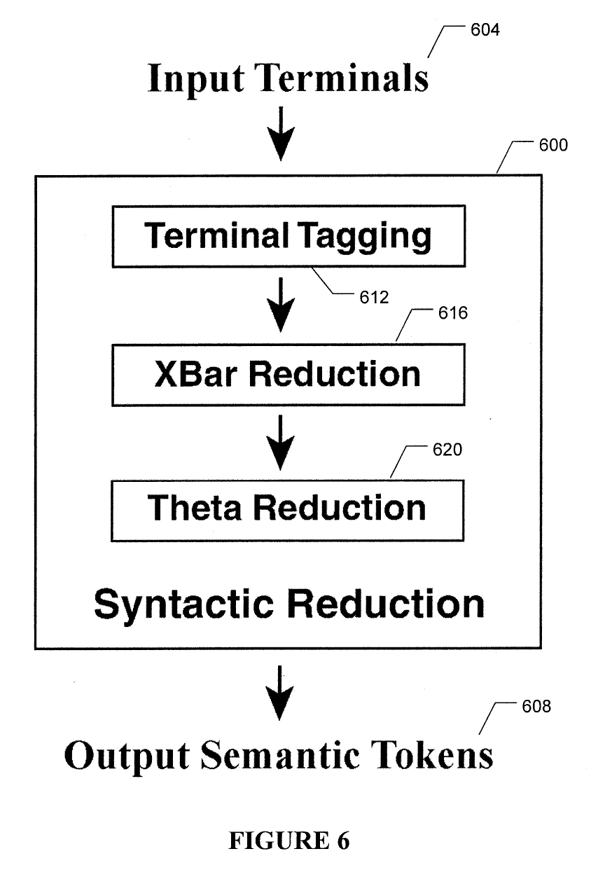

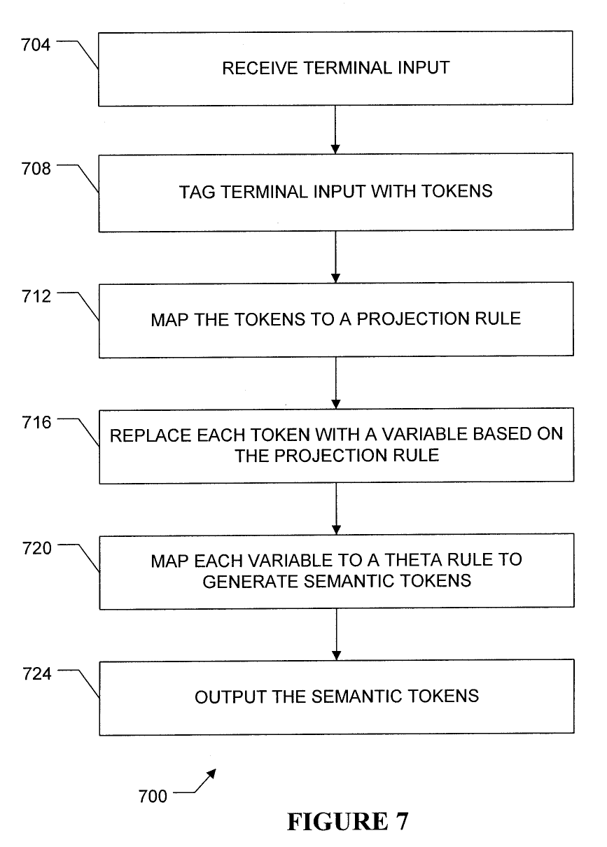

FIG. 2 illustrates the relationship of the computational natural language system and computational natural language processes. The computational natural language system includes a lexicon 200. The lexicon 200 includes the assignment rules and state changes (e.g., the data in data stores 108-120) that are used to perform the natural language processing. The lexicon 200 is used by both a generation process 400 and reduction process 600. Syntactic generation 400 takes semantic tokens and converts the tokens into output terminals, as described in further detail with reference to FIGS. 4 and 5. Syntactic reduction 600 takes terminals and converts the terminals into semantic tokens, as described in further detail with reference to FIGS. 6 and 7.

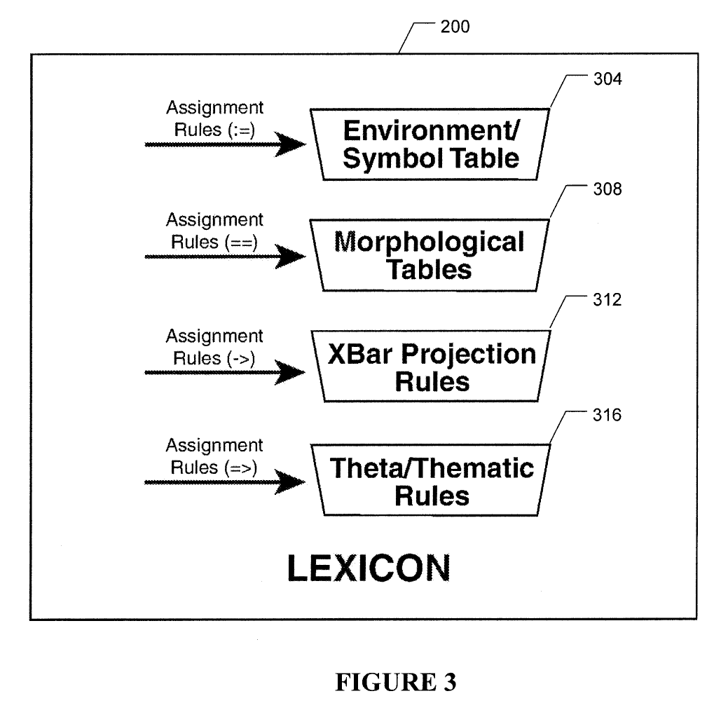

FIG. 3 illustrates the lexicon 200 in further detail. The lexicon 200 includes an environment/symbol table 304, morphological tables 308, x-bar projection rules 312 and theta/thematic rules 316. Data is loaded into the lexicon 200 by entering a series of assignment rules (i.e., corresponding environment/symbol table 304, morphological tables 308, x-bar projection rules 312 and theta/thematic rules 316). For each assignment rule type the input data is stored in one or more data objects. The following are exemplary assignment-operators:

assignment-operators: :=, →, =>, =.

An exemplary format of an assignment-rule is:

assignment-rule: key-list assignment-operator right-side-list

The right-side-list may be a combination of monadic-operators, reserved-words and token-lists, or it may be empty.

The input morphological and syntactic information along with at least a minimum amount of semantic information for natural language processing (NLP) are stored in data objects in the lexicon 200. The information can be data that is directly entered by a user or loaded from a file to specify a language. The lexicon 200 stores the description of the reduced instruction set grammar (RISG) in a series of assignment statements which include context or environment rules, morphological data, x-bar projection, and theta rules.

In one embodiment, the lexicon 200 includes the following exemplary lexicon-data-object:

```
lexicon-data-object: {
    language-name
    environment-data-object
    morphological-table-data-object
    x-bar-projection-data-object
    theta-expansion-data-object
}
environment-data-object: {
    environment-data
    current-environment-settings
}
environment-data:{
    environment-group-records
    peg-to-environment-group-mapping
    peg-position-in-environment-group
}
environment-current-settings: {
    current-peg-settings
    peg-settings-stack
}
morphological-table-data-object:{
    morphological-table-records
    terminal-tagging-data
}
x-bar-projection-data-object: {
    x-bar-class-mappings
    x-bar-class-starting-records
    x-bar-conditional-expansions
}
theta-expansion-data-object:{
    unit-production-data
    theta-starting-records
    left-side-theta-key-lists
}
```

FIG. 4 illustrates a syntactic generation process 400 according to one embodiment of the invention. As shown in FIG. 4, input semantic tokens 404 undergo the syntactic generation process 400 resulting in output terminals 408. The syntactic generation process 400 includes theta expansion 412, x-bar expansion 416 and a table lookup 420.

An exemplary syntactic expansion 400 for an exemplary French lexicon is provided below. For example, the input tokens 404 may be:

<Aller> Paris

The lexicon may include the following context sensitive rules (the first is a unit production rule and the second and third are theta rules) from French:

<City>→Paris

<Aller>→<Aller>á<City>

<Aller>→<Aller>en<FSRegion>

In theta expansion 412, the following spanning-trees are first generated from the user input tokens:

<Aller>

<Paris>=<City>

Of the available theta-rules, the input spanning trees successfully map into:

<Aller>→<Aller>á<City>

With substitution of the root tokens of the spanning-tree, the result is:

<Aller>á Paris

If the current environment settings are present tense, first person and singular, the x-bar expansion 416 yields:

<Person><Aller>á Paris

The morphological tables lookup of the x-bar expansion returns the following output terminals 408:

je vais á Paris.

FIG. 5 illustrates a computational linguistic process 500 according to one embodiment of the invention. It will be appreciated that the process 500 described below is merely exemplary and may include a lower or greater number of steps, and that the order of at least some of the steps may vary from that described below. The computational linguistic process 500 described below and shown in FIG. 5 is a syntactic expansion process. In the syntactic expansion process, semantic input (e.g., <Aller> Paris) is converted into a terminal output (e.g., Je vais á Paris) using the x-bar rules, theta rules, environmental data and the like.

The process 500 begins by receiving semantic input (block 504). For example, the semantic input may be <Aller> Paris. It will be appreciated that a user may enter <Aller> Paris or <Aller> Paris may be derived in another process using the same computer or a different computer.

The process 500 continues by mapping semantic input to a theta rule (block 508). For example, if the semantic input is <Aller> Paris, the theta rule that corresponds to <Aller> Paris is <Aller>→<Aller>á<City>because Paris is a <City>. The determination that Paris is a <City> requires a unit production to make the correlation; thus, mapping the semantic input to a theta rule may also include mapping the input to a unit production and mapping the unit production to the theta rule or replacing a portion of the semantic input (e.g., Paris) with its attribute(s). The determination may also require generation of spanning trees using the unit productions and making correlations between the spanning trees and possible theta rules.

The process 500 continues by generating at least one theta-rule clause equivalent to the semantic input with the theta rule (block 512). The target tokens are replaced by their source or root-tokens. For example, <Aller> Paris is replaced with <Aller>á Paris. If the input does not match a theta rule, the original input is returned (e.g., <Aller> Paris).

The process 500 continues by mapping each theta-rule clause to one or more x-bar projection rules (block 516). The process may include identifying a projection class using the input variable (e.g., <Aller>). For example, the projection class for <Aller> is <Verb>, and the projection rule for <Verb> is <Pronoun><Verb>. It will be appreciated that a projection rule may be located for each variable in the theta rule clause. It will also be appreciated that if a projection rule includes pegs, the pegs are evaluated with the current settings of the environment when identifying an appropriate projection rule for the variable.

The process 500 continues by modifying the theta-rule clause(s) using the x-bar projection rule (block 520). For example, the modified theta rule clause for <Aller>á Paris is <Pronoun><Aller>á Paris.

The process 500 continues by matching each token in the modified theta rule clause(s) with a terminal in a look-up table (block 524). For example, <Pronoun> and <Aller> are looked up in the table, and the variable is replaced with the terminal that corresponds to the variable using the current environment settings. If the current environment settings are the default settings (e.g., <M>, <1>, <S>), <Pronoun>corresponds to “Je” and <Aller> corresponds to “vais”. If a valid entry can be found for a variable in the table using the current settings of the environment, the variable is replaced with a terminal from the table.

The process 500 continues by outputting the terminals (block 528). For example, the terminal output is “Je vais á Paris” for <Aller> Paris. It will be appreciated that outputting the terminals may include displaying the terminals, transmitting the terminals to another computer for display on that computer, transmitting the terminals to another computer or another process for additional processing, etc. It will be appreciated that the process 500 may also optionally include capitalizing the first letter of the terminal output. Capitalizing the first letter of the terminal output may be accomplished using software code that converts the first letter of a terminal output into a capital letter; alternatively, the look-up table may include terminals that start with a capital letter for each variable in the look-up table and the table offset calculation for the look-up table may be correspondingly modified.

The process 500 may optionally include processing of swap and/or join operations. Joining is the combination of two terminals:

join-operator: terminal+terminal

For example, the tokens “should”+“n't” is equivalent to “shouldn't”. Swapping exchanges terminals (i.e., switches the order).

simple-swap-operator: <˜swap> terminal terminal

For example, if the input is <˜swap> you are sleeping, then the result is “are you sleeping”. Both swap and join operations may be performed on a given input:

terminal-swap-and-join-construct: <˜swap> terminal+terminal

The swap-and-join-construct does a swap around the join operator and then executes the join. For example, if the input is you <˜swap>n't+are sleeping, the process first performs the swap operation (e.g., “you are+n't sleeping”) and then performs the join operation (e.g., “you aren't sleeping”).

FIG. 6 illustrates a syntactic reduction process 600. As shown in FIG. 6, input terminals 604 undergo the syntactic reduction process 600 resulting in output semantic tokens 608. The syntactic reduction process 600 includes terminal tagging 612, x-bar reduction 616 and theta reduction 620. In terminal tagging 612, terminals are matched with underlying source variable and peg information from the lexicon. In x-bar reduction 616, sequences of tokens are mapped to their underlying x-bar projection variables in the lexicon. In theta reduction 620, sequences of tokens are mapped into a language's theta-rules in the lexicon using spanning-trees.

An exemplary syntactic reduction 600 for an exemplary French lexicon is provided below. For example, the input terminals 604 may be:

je vais á Paris

Terminal tagging 612 of “je” returns:

(<M><S><1>)<PP>

(<F><S><1>)<PP>

Because <M> is the default in the environment group (<Gender>:=<M><F>), (<M><S><1>)<PP> is selected. Terminal tagging 612 of “vais” returns:

(<PRESENT><S><1>)<ALLER>

No information is available for “á” and so it is treated as a standalone terminal.

The x-bar reduction 616 of “je” and “vais” is:

(<M><S><1><PRESENT>)<ALLER>

It will be appreciated that (<F><S><1><PRESENT>)<ALLER> is also possible, but because <M> is the current setting, (<M><S><1><PRESENT>)<ALLER> is selected in the above example.

For theta reduction 620, <Aller> may be associated with the following exemplary theta records:

<ALLER>→<ALLER>á<CITY>

<ALLER>→<ALLER>en<FSREGION>

<ALLER>→<ALLER>(<INF>)

For “Paris”, the following spanning tree is returned:

Paris=<City>=<Capitol>

Using the returned spanning tree for Paris, the following theta record is selected:

<ALLER>→<ALLER>á<CITY>

The selected theta records eliminates the “á” and <City> is replaced by “Paris” such that the final return tokens 608 are:

<ALLER> Paris

FIG. 7 illustrates a computational linguistic process 700. It will be appreciated that the process 700 described below is merely exemplary and may include a lower or greater number of steps, and that the order of at least some of the steps may vary from that described below. The computational linguistic process 700 described below and shown in FIG. 7 is a syntactic reduction process. In the syntactic reduction process, syntactic information is removed from terminal input (e.g., Je vais á Paris) and residual semantic information (e.g., <Aller> Paris) is returned.

The process 700 begins by receiving a terminal input (block 704). For example, the terminal input may be “Je vais a Paris”. It will be appreciated that a user may enter “Je vais á Paris” or “Je vais á Paris” may be derived in another process using the same computer or a different computer.

The process 700 continues by tagging the terminal input with tokens (block 708). Terminal tagging is a process that associates user input terminals with variables and/or with associated pegs. A terminal tag is a data object for encapsulating terminal to reverse table data mappings. The table data is stored to facilitate reverse lookups from terminal to variable and associated peg mappings in a reverse table data object. The original table data is in the form of variable to terminal mappings using the current environment settings. In English, the terminal “runs” can be mapped to the variable <Run>and have the associated pegs of <Present>, <S> and <3> (i.e., present tense, singular and third person). It will be appreciated that a terminal tag is created for each token in the input that has a matching terminal in the reverse table data. For example, a terminal tag is created for each of “Je” (e.g., <Pronoun><M><S><1>) and “vais” (e.g., <Aller>=<Verb>). The variable and associated pegs from the reverse table data record are stored in the terminal tag. It will be appreciated that if no data is found, the original input terminal is used. The reverse table data search may return multiple entries, in which a vector of terminal tags is returned for each terminal. The vector of terminal tags associated with a terminal may be put in a terminal tag vector container.

The process 700 continues by mapping the tokens to a projection rule (block 712). An x-bar reduction is the combination of two or more adjacent terminal tags into a new terminal tag (i.e., a combined terminal tag). A projection trigger is a variable that returns one or more x-bar projections from the x-bar projection data store. The current environment settings are compared with the x-bar projections to identify x-bar projections that correspond with the tokens. For example, <Pronoun><Aller> corresponds to the x-bar projection rule: <Verb>=><Pronoun><Verb>. In one embodiment, the x-bar-reduction returns:

```
x-bar-solution: {
    number-x-bar-triggers
    number-x-bar-reductions
    original-terminal-tags
    tags-after-reduction
}
```

The process 700 continues by replacing each token with a variable based on the projection rule (block 716). If the reduction is successful, a new terminal tag is created containing that reduction and replaces the terminal tags covered by the projection. For example, <Pronoun><Verb> is reduced to <Verb> using the x-bar projection rule: <Verb>=><Pronoun><Verb>. Next, the <Verb> on the right side of the x-bar projection rule is replaced with <Aller>. It will be appreciated that if the terminal tags cannot be mapped to an x-bar projection rule, the original terminal tags may be returned. In one embodiment, the process 700 also includes making adjustments for any swap and join operators in the input (not shown).

The process 700 continues by mapping each variable to a theta rule to generate semantic tokens (block 720). Related theta rules are identified that correspond to the variable in the combined terminal tag and generated terminal tags. For example, the theta record <Aller>→<Aller>á<City> is triggered for the terminal tag <Aller>. The spanning trees from the terminal tags are mapped into the theta rule to identify that the theta rule can be applied to the tags. In the example, the spanning tree for Paris is also generated (i.e., Paris=<City>). Since the terminal tags successfully map to the theta rule, the theta rule is accepted and the tokens on the left side of the theta rule are returned (e.g., <Aller>).

The process 700 continues by outputting the semantic tokens (block 724). For example, <Aller> Paris may be outputted. It will be appreciated that outputting the semantic tokens may include displaying the terminals, transmitting the semantic tokens to another computer for display on that computer, transmitting the semantic tokens to another computer or another process for additional processing, etc.

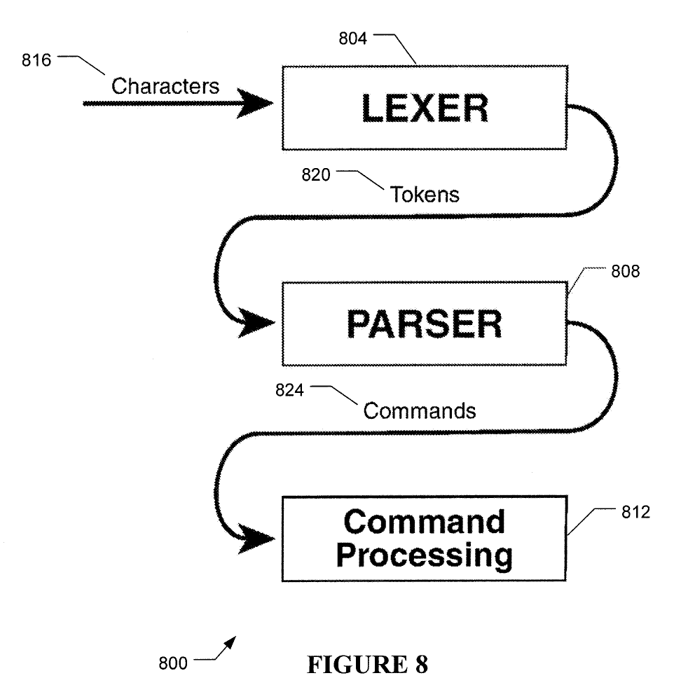

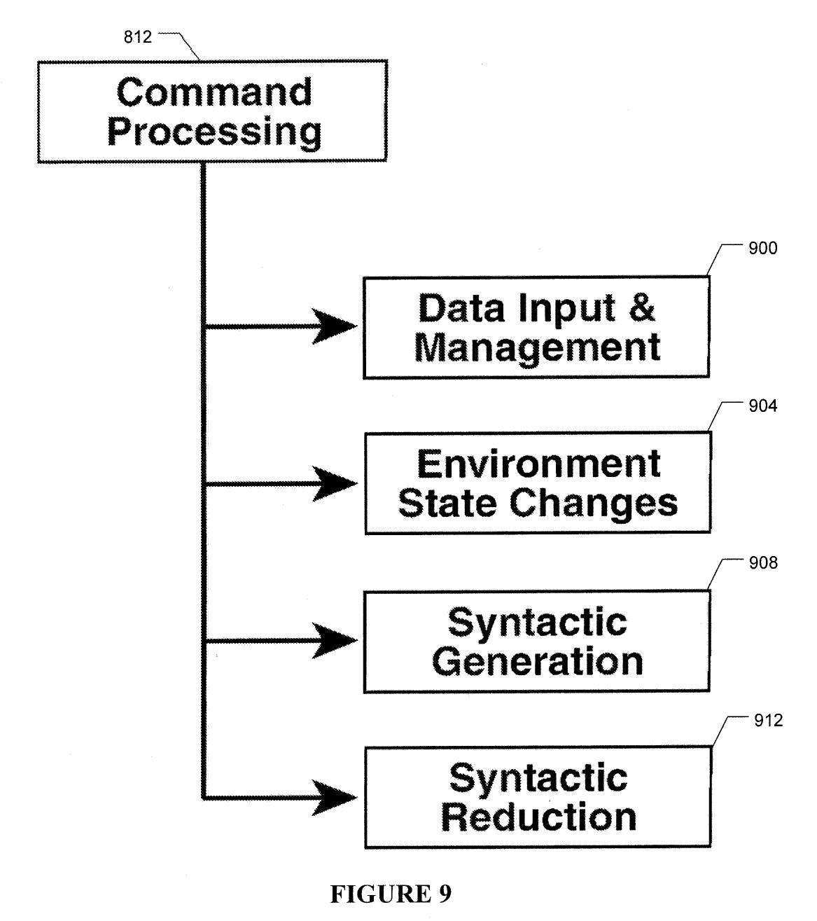

FIGS. 8 and 9 illustrate a computational language system 800 according to one embodiment of the invention. As shown in FIG. 8, the system 800 includes a lexer 804, a parser 808 and command processing 812. Characters 816 are received at the lexer 804 which produces tokens 820. The tokens 820 are parsed by the parser 808 to generate commands (i.e., statements) 824 which are processed at the command processing 812. The commands 824 are typically processed by the command processing 812 one at a time. As shown in FIG. 9, the command processing 812 is in communication with data input and management 900, environment state changes 904, syntactic generation 908 and syntactic reduction 912. The data input and management 900 pulls data in or loads data into the system from files or retrieves data from a user interface. The environment state changes 904 is configured to store the morphological data (e.g., the current environment setting) that is needed to decode the morphological table. The syntactic generation 908 performs a syntactic generation process as described above with reference to FIGS. 4 and 5. The syntactic reduction 912 process performs a syntactic reduction process as described above with reference to FIGS. 6 and 7.

FIG. 10 illustrates a process 1000 for changing the current environment setting. It will be appreciated that the process 1000 described below is merely exemplary and may include a lower or greater number of steps, and that the order of at least some of the steps may vary from that described below. The current group settings can be saved with a push operation and restored with a pop (or pull) operation using a stack.

The process 1000 begins by setting a current peg for a group to first peg in initial assignment rule (block 1004) and continues by determining if a received token 1008 is a peg (block 1012). For example, the initial default settings may be <M>, <S> and <1>. If no, the process 1000 continues to no change to current peg for this group (block 1016). If yes, the process continues by determining if the peg is in this group (block 1020). If no, the process 1000 continues to block 1016 (i.e., no change to the environment settings is made). If yes, the process 1000 continues by resetting the current peg for this group (block 1020). For example, if the environment detects a peg (e.g., <3>) in the environment <Person>, it changes the value of <Person> to that peg (e.g., changes the <1> to a <3>.

FIG. 11 illustrates a theta rule identification process 1100. It will be appreciated that the process 1100 described below is merely exemplary and may include a lower or greater number of steps, and that the order of at least some of the steps may vary from that described below.

The process 1100 begins by inputting tokens 1104, and continues by finding all unit productions for input semantic tokens and building spanning trees (block 1108). Theta key variables 1112 are also used to find the left side key lists for theta key variable (block 1116) to find all theta rules associated with the key lists (block 1120). For example, if the input is “<Aller> Paris,” the spanning tree for Paris is generated (e.g., Paris=<City>). At the same time, the theta rules for <Aller> are identified (e.g., <Aller>→<Aller>á<City> and <Aller>→<Aller>en<FSRegion>.

From both block 1108 and block 1120, the process 1100 continues by determining if the spanning trees map into the theta rule (block 1124). If no, the theta rule is rejected (block 1128). For example, <City> maps into <Aller>á<City>but not <Aller>en<FSRegion>. Thus, <Aller>en<FSRegion> is rejected. If yes, the process 1100 continues by replacing variables in the theta rule with the root terminals (block 1132) and returning the theta rule (block 1136). For example, <Aller>á Paris is returned.

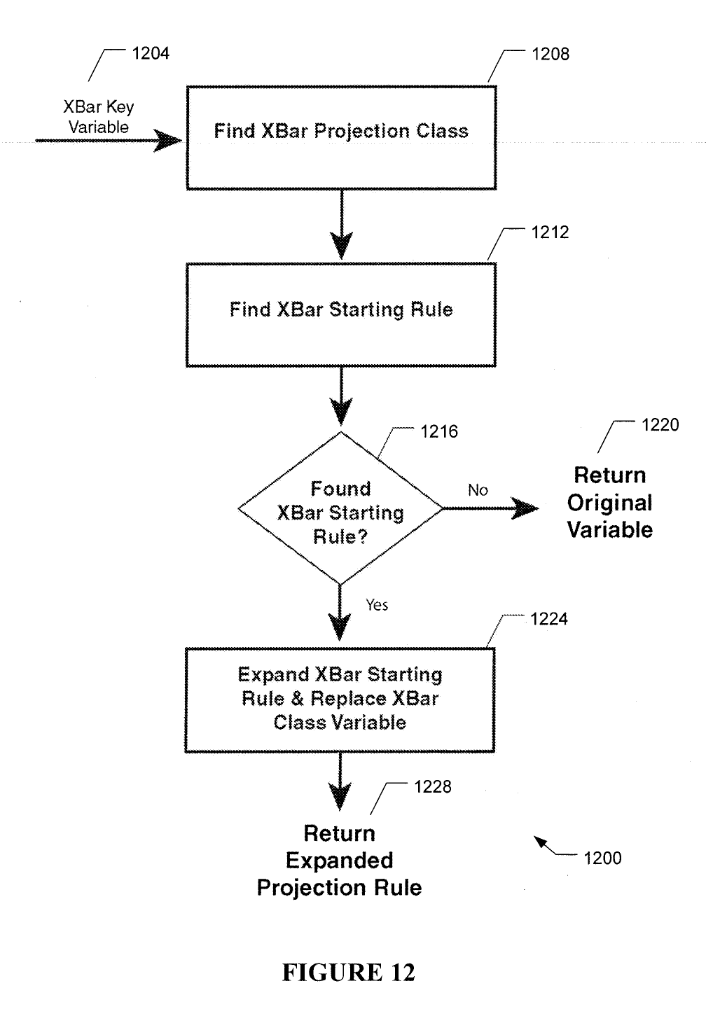

FIG. 12 illustrates an x-bar projection rule identification process 1200. It will be appreciated that the process 1200 described below is merely exemplary and may include a lower or greater number of steps, and that the order of at least some of the steps may vary from that described below.

The process 1200 begins with an x-bar key variable 1204 and finding the x-bar projection class for the x-bar key variable 1204 (block 1208). For example, the x-bar key variable 1204 for <Aller> Paris is <Aller>.

The process 1200 continues by finding an x-bar starting rule (block 1212). In particular, the process 1200 identifies the xbar-projection-class by matching an input variable with the available xbar-class-variables and retrieving the xbar-starting-rule for the selected class. A conditional-phrase-structure-rule in which the left side variable appears also on the right side is considered to be an xbar-starting-rule. Otherwise, a conditional-phase-structure-rule is considered to be an xbar-expansion-rule or a projection-class-assignment. The variable on the left side of an xbar-starting-rule is an xbar-class-variable. Some exemplary formats of x-bar starting rules are:

xbar-starting-rule:
xbar-class-variable=>variable-list xbar-class-variable
xbar-class-variable=>xbar-class-variable variable-list
xbar-class-variable=>variable-list xbar-class-variable variable-list
   The variable-lists of the x-bar starting rules may not be empty. Exemplary xbar-starting-rules in the English language include:

<Verb>=><Pronoun><Verb>

<Verb>=><Pronoun><Aux><Verb>

In the above examples, <Verb> is the xbar-class-variable of the xbar-starting-rules. An xbar-projection-class is a collection of conditional-phrase-structure-rules referenced by variable expansion of an xbar-starting-rule. A variable may be expanded once. Variables can be assigned to an xbar-class-variable. An exemplary format for assigning variables to an x-bar class variable is:

xbar-class-assignment:
variable=>xbar-class-variable
   A typical example in English is:

<Run>=><Verb>

In other words, the variable <Run> is assigned to the xbar-projection class <Verb>.

The process 1200 continues by determining whether an x-bar starting rule has been found (block 1216). If no, the original variable is returned 1220. If yes, the process 1200 continues by expanding the x-bar starting rule and replacing the x-bar class variable (block 1224) and returning the expanded projection rule 1228. In particular, the indicated conditional-phrase-structure-rule expansions are performed on the found x-bar-starting-rule based on the current morphological state of the system, and the xbar-class-variable on the right side is replaced with the original input variable.

An exemplary x-bar projection will now be described. In the example, the following exemplary environment groups and rules are used:

| | |
|---|---|
| <Group> := <Peg1> <Peg2> | // Environment Definition |
| <Verb> => <Pronoun> <Auxiliary> <Verb> | // Initial Starting Rule |
| <Auxiliary> => ( <Peg2> ) <Do> | // Conditional Expansion |
| <Run> => <Verb> | // XBar Class Assignment |

If the process begins with the variable <Run>, the xbar-projection-class that is returned is <Verb>. The verbal expansion of <Verb> if then performed. For example, the initial starting rule for <Verb> is:

<Verb>=><Pronoun><Auxiliary><Verb>

If the current morphological state of <Group> is <Peg1> then <Auxiliary>has no definition (or a <NULL> expansion). The full projection for this state is:

<Verb>=><Pronoun><Null><Verb>

which reduces with elimination of the <Null> to:

<Verb>=><Pronoun><Verb>

Finally, <Verb>, the xbar-class-variable, is replaced with the original variable <Run>:

<Verb>=><Pronoun><Run>

However, if the current morphological state of <Group>is <Peg2>, then <Auxiliary> is replaced with <Do> and the full projection is:

<Verb>=><Pronoun><Do><Verb>

Finally, the XBar Class <Verb> is replaced with the original variable:

<Verb>=><Pronoun><Do><Run>

If the terminal definitions are:

<Pronoun>=>

<Do>=>did

<Run>=>run

Then, the terminal replacements for the above projection rules are:

<Pronoun><Run>

I run

<Pronoun><Do><Run>

I did run

In the example above, the variables are directly replaced with terminals using the exemplary terminal definitions (i.e., a terminal replacement). It will be appreciated, however, that the terminal replacements are usually done using the morphological lookup tables. An exemplary morphological state or environment for the English language is:

<Gender>:=<M><F>

<Person>:<1><2><3>

<Number>:=<S><P>

<Tense>:=<Present><Past>

and exemplary x-bar rules and morphological table entries for the English language include:

<Verb>=><PP><Verb>

<Run>=><Verb>

<PP>(<M><Number><Person>) I, you, he, we, you, they

<PP>(<F><Number><Person>) I, you, she, we, you, they

<Run>(<Present><Number><Person>) run, run, runs, run, run, run

<Run>(<Past>) ran

If the current morphological settings in the environment are <M><1><S><Present>, the variable <Run> would derive:

| | |
|---|---|
| <Run> => <Verb> | // XBar Class |
| <Verb> => <PP> <Verb> | // XBar Starting Rule |
| <Verb> => <PP> <Run> | // XBar Variable Replacement |
| <Run> == I run | // Morphological Lookup |

However, if the current morphological settings in the environment are <F><3><S><Past>, the variable <Run> would instead derive:

| | |
|---|---|
| <Run> => <Verb> | // XBar Class |
| <Verb> => <PP> <Verb> | // XBar Starting Rule |
| <Verb> => <PP> <Run> | // XBar Variable Replacement |
| <Run> == she runs | // Morphological Lookup |

It will be appreciated that in some circumstances multiple element x-bar projections are required. For example, French negation causes interesting problems for most grammars. Assume that:

| | |
|---|---|
| <~Negation> := <Positive> <Negative> | // Environment |
| | Definition |
| <Verb> => <PP> <NP1> <Etre> <NP2> <Verb> | // XBar Starting Rule |
| <Aller> => <Verb> | // Class Assignment |
| <NP1> => ( <Negative> ) ne | // Conditional |
| | Expansions |
| <NP2> => ( <Negative> ) pas | |
| <PP> => je | // Terminal |
| | Replacements |
| <Etre> => suis | |
| <Aller> => allé | |

The ‘˜’ (tilda) in <˜Negation> is an arbitrary character used in this and other examples to indicate an environment-group-variable. It will be appreciated that different notations can be used. It should also be noted that variables with English names and French terminals may be used to return acceptable French phrases. In the above example, <NP1>and <NP2>are used to get a paired expansion in this case because of variables are only expanded once in an x-bar derivation. If the current morphological setting is <Positive>, then the x-bar projection is:

| | |
|---|---|
| <Aller> | |
| <Aller> => <Verb> | // XBar Class |
| <Aller> => <PP> <NP1> <Etre> <NP2> <Verb> | // XBar Starting Rule |
| <Aller> => <PP> <Null> <Etre> <NP2> <Verb> | // Conditional |
| | Expansion |
| <Aller> => <PP> <Null> <Etre> <Null> <Verb> | // Conditional |
| | Expansion |
| <Aller> => <PP> <Etre> <Verb> | // <Null> Elimination |
| <Aller> => <PP> <Etre> <Aller> | // Class Replacement |
| <Aller> => je suis allé | // Terminal |
| | Replacements |

It will be appreciated that the <Null> elimination can occur at any point in the process. If the current morphological setting is <Negative>, then the x-bar projection is:

| | |
|---|---|
| <Aller> | |
| <Aller> => <Verb> | // XBar Class |
| <Aller> => <PP> <NP1> <Etre> <NP2> <Verb> | // XBar Starting Rule |
| <Aller> => <PP> ne <Etre> <NP2> <Verb> | // Conditional |
| | Expansion |
| <Aller> => <PP> ne <Etre> pas <Verb> | // Conditional |
| | Expansion |
| <Aller> => <PP> ne<Etre> pas <Aller> | // Class Replacement |
| <Aller> => je ne suis pas allé | // Terminal |
| | Replacements |

In a similar fashion, it is possible to introduce special system variables like the swap and the join operators into an x-bar projection. For example, the join operation can be used to add punctuation to a statement. For example, the following rules may be used to add punctuation to statements:

| | |
|---|---|
| <~Question> := <−Q> <+Q> | // Environment Definition |
| <Punc> => ( <−Q> ) + . | // Period Conditional Expansion |
| <Punc> => ( <+Q> ) + ? | // Question Mark Conditional Expansion |

The punctuation mark (e.g., “.”, “?”) is preceded by a ‘+’ join operator. In English, the punctuation mark is attached to the preceding terminal. The following is an exemplary xbar-starting-rule:

<Verb>=><PP><Verb><Punc>

<Punc> results in two terminals when it is conditionally expanded (e.g., a plus sign and a punctuation mark). Depending on the state of <˜Question>, either a period or question mark is added at the end of the sentence. After x-bar projection, the terminals may be as follows:

you run+.

After join processing, the result is:

you run.

In another example, the xbar-starting-rule is:

<Verb>=><Quest><PP><Neg><Aux><Verb>

For a question, the relevant inputs are:

| | |
|---|---|
| <~Question> := <−Q> <+Q> | // Environment |
| <Quest> => ( <−Q> ) _{—} | // No Question |
| <Quest> => ( <+Q> ) <~Swap> | // Question |

The minus sign is used to denote the no question case (<−Q>). The plus sign is used to indicate that there is a question (<+Q>). This is an arbitrary convention but useful in definition of complex environments. For negation, the relevant inputs are:

| | |
|---|---|
| <~Negation> := <−Neg> <+Not> <+Nt> | // Environment |
| <Neg> => ( <−Neg> ) _{—} | // No Negation |
| <Neg> => ( <+Not> ) <~Swap> not | // “not” Negation |
| <Neg> => ( <+NT> ) <~Swap> n't + | // “n't” Negation |

The minus sign in (<−Neg>) is used to denote “not negation” or “no negation”. The plus sign in (<+Not>) and (<+NT>) is used to indicate the particular type of negation using a “not” or “n't”. The concatenation of the “n't” on the trailing <Aux> or auxiliary verb using a swap and a join. If the current state of the environment is <+Q><−Neg>, the xbar-starting-rule is expanded to:

<˜Swap><PP><Aux><Verb>

If <Aux> expands to at least one terminal, the <˜Swap> exchanges the <PP> and the first terminal of <Aux>.

[first terminal of <Aux>]<PP>[rest of <Aux> expansion]<Verb>

The ‘[ . . . ]’ structure represents a single token for this analysis.

If the current state of the environment is <−Q><+Not>, the xbar-starting-rule is expanded to:

<PP><˜Swap>not<Aux><Verb>

If <Aux> expands to at least one terminal, the <˜Swap> will exchange the first terminal of the <Aux> expansion and the “not”. The result is:

<PP>[first terminal of <Aux>] not [rest of <Aux> expansion]<Verb>

If the current state of the environment is <−Q><+NT>, the xbar-starting-rule is expanded to:

<PP><˜Swap>n't+<Aux><Verb>

If <Aux> expands to at least one terminal, the <˜Swap> will rotate the first terminal of the <Aux> expansion and the “n't” around the ‘+’ (join-operator). The result is:

<PP>[first terminal of <Aux>]+n't [rest of <Aux> expansion]<Verb>

Then, the first terminal of <Aux> is joined with the n't using the ‘+’ join-operator).

It will be appreciated that although a morphological look-up table is described as being part of the system and processes, the systems and processes do not need a morphological look-up table. In one embodiment, a statistical machine translation (SMT) approach may be used in place of the morphological look-up table. For example, the system may include a data store having a plurality of translation rules generated using the SMT approach. The processor can then use the translation rules to replace tokens with terminals and/or tag terminals with tokens. It will be appreciated that the theta-rules and x-bar rules improve the SMT approach because the quality of the translations will be improved. Another advantage of the approach described herein is improvement in computational efficiency of the conventional SMT approach.

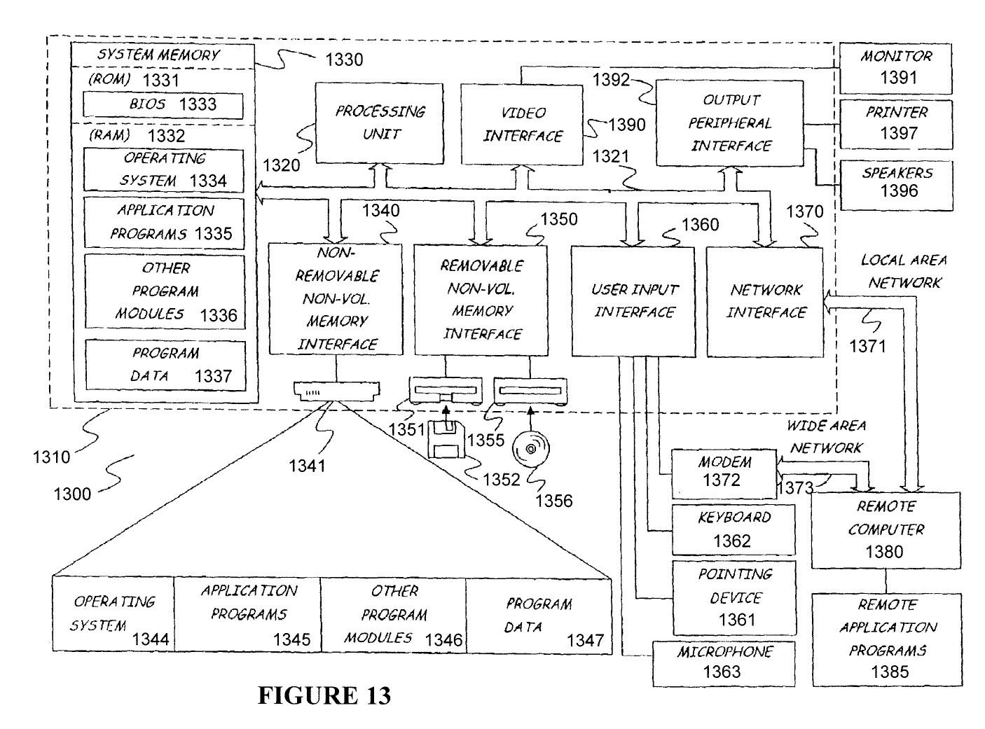

FIG. 13 illustrates an example of a suitable computing system environment 1300 on which the invention may be implemented. The computing system environment 1300 is only one example of a suitable computing environment and is not intended to suggest any limitation as to the scope of use or functionality of the invention. Neither should the computing environment 1300 be interpreted as having any dependency or requirement relating to any one or combination of components illustrated in the exemplary operating environment 1300.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, cell phones, multiprocessor systems, microprocessor-based systems, set top boxes, programmable consumer electronics, network PCs, minicomputers, mainframe computers, custom integrated circuits, accelerator cards, and distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The modules may be configured to transform data (e.g., transform syntactic data to terminal data and/or vice versa). The invention may also be practiced in distributed computing environments where tasks are performed by remote processing devices that are linked through a communications network. In a distributed computing environment, program modules may be located in both local and remote computer storage media including memory storage devices.

With reference to FIG. 13, an exemplary system for implementing the invention includes a general purpose computing device in the form of a computer 13 10. Components of computer 1310 may include, but are not limited to, a processing unit 1320, a system memory 1330, and a system bus 1321 that couples various system components including the system memory to the processing unit 1320. The system bus 1321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1310 typically includes a variety of computer readable media. Computer readable media can be any available media that can be accessed by computer 1310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1300. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radiofrequency (RF), infrared and other wireless media. Combinations of any of the above should also be included within the scope of computer readable media.

The system memory 1330 includes computer storage media in the form of volatile and/or nonvolatile memory such as read only memory (ROM) 1331 and random access memory (RAM) 1332. A basic input/output system 1333 (BIOS), containing the basic routines that help to transfer information between elements within computer 1310, such as during start-up, is typically stored in ROM 1331. RAM 1332 typically contains data and/or program modules that are immediately accessible to and/or presently being operated on by processing unit 1320. By way of example, and not limitation, FIG. 13 illustrates operating system 1334, application programs 1335, other program modules 1336, and program data 1337.

The computer 1310 may also include other removable/non-removable volatile/nonvolatile computer storage media. By way of example only, FIG. 13 illustrates a hard disk drive 1341 that reads from or writes to non-removable, nonvolatile magnetic media, a magnetic disk drive 1351 that reads from or writes to a removable, nonvolatile magnetic disk 1352, and an optical disk drive 1355 that reads from or writes to a removable, nonvolatile optical disk 1356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1341 is typically connected to the system bus 1321 through a non-removable memory interface such as interface 1340, and magnetic disk drive 1351 and optical disk drive 1355 are typically connected to the system bus 1321 by a removable memory interface, such as interface 1350.

The drives and their associated computer storage media discussed above and illustrated in FIG. 13, provide storage of computer readable instructions, data structures, program modules and other data for the computer 1310. In FIG. 13, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337. Operating system 1344, application programs 1345, other program modules 1346, and program data 1347 are given different numbers here to illustrate that, at a minimum, they are different copies.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite dish, scanner, or the like. These and other input devices are often connected to the processing unit 1320 through a user input interface 1360 that is coupled to the system bus, but may be connected by other interface and bus structures, such as a parallel port, game port or a universal serial bus (USB). A monitor 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1392.

The computer 1310 may operate in a networked environment using logical connections to one or more remote computers, such as a remote computer 1380. The remote computer 1380 may be a personal computer, a hand-held device, a server, a router, a network PC, a peer device or other common network node, and typically includes many or all of the elements described above relative to the computer 1310. The logical connections depicted in FIG. 13 include a local area network (LAN) 1371 and a wide area network (WAN) 1373, but may also include other networks. Such networking environments are commonplace in offices, enterprise-wide computer networks, intranets and the Internet.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. The modem 1372, which may be internal or external, may be connected to the system bus 1321 via the user input interface 1360, or other appropriate mechanism. In a networked environment, program modules depicted relative to the computer 1310, or portions thereof, may be stored in the remote memory storage device. By way of example, and not limitation, FIG. 13 illustrates remote application programs 1385 as residing on remote computer 1380. It will be appreciated that the network connections shown are exemplary and other means of establishing a communications link between the computers may be used.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A natural language processing system comprising:
a data store having a plurality of x-bar rules;
a data store having a plurality of theta rules; and
a processor to receive an input, process the input using at least the one or more of the x-bar rules and the one or more of the theta rules to produce an output.

2. The system of claim 1, wherein the data store having a plurality of x-bar rules comprises a plurality of x-bar starting rules and a plurality of x-bar expansion rules.

3. The system of claim 1, further comprising a data store having a morphological look-up table.

4. The system of claim 3, wherein the processor further processes the input using the morphological look-up table to produce the output.

5. The system of claim 1, further comprising a data store having a plurality of statistically generated translation rules.

6. The system of claim 3, wherein the processor further processes the input using at least one of the plurality of statistically generated translation rules to produce the output.

7. The system of claim 1, further comprising a data store having environment data.

8. The system of claim 7 wherein the data store having environment data stores environment settings and wherein the environment settings are nested using a push down stack.

9. The system of claim 7 wherein the processor further processes the input using the environment data.

10. The system of claim 1, wherein the input comprises semantic tokens.

11. The system of claim 10, wherein the processor is configured to perform a syntactic expansion of the semantic tokens using at least the one or more theta rules and one or more x-bar rules to produce terminals.

12. The system of claim 1, wherein the input comprises terminals.

13. The system of claim 12, wherein the processor is configured to perform a syntactic reduction of the terminals using at least the one or more x-bar rules, and one or more theta rules to produce semantic tokens.

14. The system of claim 3, wherein the morphological look-up table comprises morphological table data and terminal tagging data.

15. The system of claim 1, wherein the processor is configured to:
select at least one of the x-bar rules and at least one of the theta rules when the processor is processing the input if at least one of the x-bar rules and at least one of the theta rules are mappable to the input;
select at least one of the x-bar rules if at least one of the x-bar rules is mappable to the input and no theta rules are mappable to the input;
select at least one of the theta rules if the at least one of the theta rules is mappable to the input and no x-bar rules are mappable to the input; and
process the input if no theta rules and no x-bar rules are mappable to the input.

16. The system of claim 3, wherein the system comprises a lexicon, the lexicon comprising the data store having the morphological look-up table, the data store having the plurality of x-bar rules, and the data store having the plurality of theta rules.

17. The system of claim 1, wherein each theta rule comprises a key list, an operator and one or more tokens, and wherein each token comprises a variable or a terminal.

18. The system of claim 17, wherein the input comprises one or more tokens, each token comprising a variable or a terminal, and wherein the processor is configured to:
map at least one token in the input to the key list to identify a theta rule; and
replace the at least one token in the input with the one or more tokens of the identified theta rule.

19. The system of claim 1, wherein the x-bar rules are conditional phrase structure rules.

20. The system of claim 3, wherein the morphological table comprises a plurality of table records, each table record including a preamble that is an environment list and a terminal list corresponding to the preamble.

21. The system of claim 20, wherein the processor is configured to decode the table record based on one or more current environment settings and the preamble, and to identify a terminal in the terminal list by calculating a table offset based on the one or more current environmental settings for the morphological table.

22. The system of claim 1, further comprising a data store having a plurality of unit production rules.

23. The system of claim 22, wherein the processor is configured to identify one or more unit production rules and generates one or more spanning trees or groups of spanning trees for the input and map each of the one or more spanning trees or groups of spanning trees to at least one of the plurality of theta rules.

24. The system of claim 22, wherein each unit production includes an attribute corresponding to a token.

25. The system of claim 24, wherein the processor is configured to identify a unit production rule for the input by matching a token in the input with the token in the unit production.

26. A machine readable medium containing executable instructions which cause a data processing system to perform a method comprising:
receiving a semantic input;
mapping the semantic input to at least one theta rule to generate at least one theta-rule clause;
mapping each theta-rule clause to one or more x-bar rules;
modifying each theta-rule clause with the one or more x-bar rules; and
replacing tokens of the modified theta-rule clause with terminals to generate a terminal output.

27. The machine readable medium of claim 26 wherein the input comprises one or more tokens, each token comprising a variable or a terminal, and further comprising:
mapping at least one token in the input to the key list to identify a theta rule; and
replacing each token in the input with the one or more tokens of the identified theta rule.

28. The machine readable medium of claim 26, wherein mapping the semantic input to a theta rule comprises generating one or more spanning trees from the semantic input and mapping the one or more spanning trees to the at least one theta rule.

29. The machine readable medium of claim 26, further comprising determining environment data for the semantic input.

30. The machine readable medium of claim 29, wherein a setting for the environment data is initialized with a default value.

31. The machine readable medium of claim 30, further comprising changing the setting for the environment data if a peg in the semantic input corresponds to an environment group in an environment data store based on an environment rule.

32. The machine readable medium of claim 31, wherein the settings for the environment data are nested using a push down stack.

33. The machine readable medium of claim 29, further comprising attaching environment data to the input using one or more unit productions.

34. The machine readable medium of claim 33, wherein the one or more unit productions each assign one or more attributes to one or more tokens in the semantic input.

35. The machine readable medium of claim 27, further comprising identifying an x-bar rule based on the one or more variables in the semantic input.

36. The machine readable medium of claim 26, further comprising identifying an x-bar starting rule and one or more x-bar expansion rules corresponding to one or more variables in the x-bar starting rule, and wherein if the x-bar expansion rule comprises pegs, evaluating a current setting of environment data and, if the pegs in the x-bar expansion rule correspond to the current setting, replacing each variable in the x-bar starting rule with non-peg tokens in the x-bar expansion rule.

37. The machine readable medium of claim 26, further comprising performing one or more swap and join operations on the terminals before outputting the terminal output.

38. A machine readable medium containing executable instructions which cause a data processing system to perform a method comprising:
receiving a terminal input;
assigning a terminal tag containing one or more tokens to each terminal in the terminal input;
mapping the assigned terminal tags to at least one x-bar rule;
replacing the assigned terminal tags with x-bar reduced terminal tags using the at least one x-bar rule;
mapping the x-bar reduced terminal tags to at least one theta rule to generate semantic output; and
outputting the semantic output.

39. The machine readable medium of claim 38, wherein assigning the terminal tag comprises matching the terminal input with one or more tokens and one or more pegs.

40. The machine readable medium of claim 38, wherein mapping the terminal tags to at least one x-bar rule comprises combining two or more adjacent terminal tags into a set of x-bar reduced terminal tags.

41. The machine readable medium of claim 38, wherein mapping the x-bar reduced terminal tags to the at least one theta rule further comprises generating one or more spanning trees or groups of spanning trees for the x-bar reduced terminal tags and mapping the one or more spanning trees or groups of spanning trees to at least one theta rule.

42. The machine readable medium of claim 38, further comprising performing one or more swap and join operations on the terminal input.

43. The machine readable medium of claim 38, further comprising performing one or more swap and join operations on the semantic output.

44. A machine readable medium containing executable instructions which cause a data processing system to perform a method comprising:
receiving a semantic input;
performing a theta rule expansion on the semantic input;
performing an x-bar expansion on one or more variables of the theta rule expanded semantic input; and
performing a morphological table lookup on the x-bar and theta rule expanded semantic input to generate a terminal output.

45. The machine readable medium of claim 44, wherein performing the x-bar expansion comprises:
performing an x-bar expansion with one or more x-bar starting rules; and
performing an x-bar expansion with one or more x-bar expansion rules.

46. A machine readable medium containing executable instructions which cause a data processing system to perform a method comprising:
receiving a terminal input;
tagging the terminal input to match the terminal input with one or more variables and one or more pegs using a reverse lookup table;
performing one or more x-bar reductions on the tagged terminal input; and
performing a theta reduction on the x-bar reduced tagged terminal input to generate a semantic output.

47. A natural language processing system comprising:
a data store having a morphological look-up table;
a data store having a plurality of x-bar rules;
a data store having a plurality of theta rules;
a data store having environment data;
a data store having a plurality of unit production rules; and
a processor to receive an input, process the input using the one or more of the x-bar rules, one or more of the theta rules, one or more of the plurality of unit production rules, the environment data and the morphological look-up table to produce an output.

48. The system of claim 47 wherein the input comprises terminals.

49. The system of claim 47 wherein the input comprises semantic tokens.
